(19) United States
(12) Patent Application Publication
(10) Pub. No.: US 2021/0012397 A1
(43) Pub. Date: Jan. 14, 2021

(54) INFORMATION PROCESSING APPARATUS, CONTROL METHOD, AND PROGRAM

(71) Applicant: NEC Corporation, Minato-ku, Tokyo (JP)

(72) Inventors: Yang LU, Tokyo (JP); Saika GOTO, Tokyo (JP)

(73) Assignee: NEC Corporation, Minato-ku, Tokyo (JP)

(21) Appl. No.: 16/980,179

(22) PCT Filed: Mar. 12, 2019
(86) PCT No.: PCT/JP2019/010015

§ 371 Date: Sep. 11, 2020

(30) Foreign Application Priority Data
Mar. 20, 2018 (JP) 2018-052732

(51) Int. Cl. G06Q 30/02; G06T 7/62; G06T 11/00; G06Q 10/08; G06F 16/28

(52) U.S. Cl. CPC G06Q 30/0283; G06T 7/62; G06F 16/285; G06Q 10/0832; G06T 11/00

(57) ABSTRACT

An information processing device acquires shape information (30) indicating a three-dimensional shape of a delivery object (10). The information processing device specifies a rectangular parallelepiped (circumscribed rectangular parallelepiped (20)) circumscribed on the delivery object (10), based on the shape information (30). Then, the information processing device computes a total value of three sides of the specified circumscribed rectangular parallelepiped (20), and outputs information representing the total value of the three sides.

### TECHNICAL FIELD

The present invention relates to delivery of a delivery object.

### BACKGROUND ART

As one of methods of determining a delivery price of a delivery object, there is a method of determining a delivery price, based on a size of a delivery object. PTLs 1 to 3 disclose a device including a function of measuring a size of a delivery object. PTL 1 discloses a technique for measuring a size of a home-delivery object that is not packed, and determining a packing material with which the home-delivery object is packed. PTL 2 discloses a technique, in a home-delivery box device including a plurality of types of home-delivery object storage units having different heights, for determining a home-delivery object storage unit suitable for a home-delivery object by measuring a height of the home-delivery object by using an infrared ray with a box for measurement. PTL 3 discloses a technique for measuring a length of the longest side of a home-delivery object by using a camera.

### RELATED DOCUMENT

### Patent Literature

[PTL 1] Japanese Patent Application Publication No. 2015-222572

[PTL 2] Japanese Patent Application Publication No. 2014-166924

[PTL 3] Japanese Patent Application Publication No. 2006-119792

### SUMMARY OF INVENTION

### Technical Problem

As an indicator representing a size of a delivery object for determining the delivery object, for example, there is a total value of lengths of a length, a width, and a height of a rectangular parallelepiped that contains the delivery object. For example, a numerical range which the total value may take is divided into a plurality of classifications, and a delivery price is previously determined for each of the classifications. A delivery price of a delivery object is a delivery price associated with a classification including a total value of a length, a width, and a height of the delivery object.

Herein, some delivery objects have a shape other than a rectangular parallelepiped. Examples include a bag in which an object desired to be delivered is housed and the like. When a delivery price of such a delivery object having a shape other than a rectangular parallelepiped is also determined with the same criterion as that of a delivery object of a rectangular parallelepiped, the delivery object is regarded as a rectangular parallelepiped, lengths of a length, a width, and a height thereof are measured, and the delivery price is determined based on a total value of the lengths.

When a delivery object is regarded as a rectangular parallelepiped by a person, variations occur from operator to operator. For this reason, even with the same delivery object, a delivery price may vary from operator to operator. In other words, in a method of regarding a delivery object as a rectangular parallelepiped by an operator and measuring a height and the like thereof, a delivery price cannot be accurately computed.

The present invention has been made in view of the above-described problem. One of objects of the present invention is to provide a technique capable of accurately computing a delivery price of a delivery object having a shape other than a rectangular parallelepiped.

### Solution to Problem

An information processing device according to the present invention includes (1) an acquisition unit that acquires shape information indicating a three-dimensional shape of a delivery object, (2) a specification unit that specifies a first rectangular parallelepiped circumscribed on the delivery object by using the shape information, and computes a total value of lengths of a length, a width, and a height of the first rectangular parallelepiped, and (3) an output unit that outputs the computed total value.

A control method according to the present invention includes (1) an acquisition step of acquiring shape information indicating a three-dimensional shape of a delivery object, (2) a specification step of specifying a first rectangular parallelepiped circumscribed on the delivery object by using the shape information, and computing a total value of lengths of a length, a width, and a height of the first rectangular parallelepiped, and (3) an output step of outputting the computed total value.

A program according to the present invention causes a computer to execute each step included in the control method according to the present invention.

### Advantageous Effects of Invention

The present invention provides a technique capable of accurately computing a delivery price of a delivery object having a shape other than a rectangular parallelepiped.

### BRIEF DESCRIPTION OF DRAWINGS

The above-described object, the other objects, features, and advantages will become more apparent from suitable example embodiments described below and the following accompanying drawings.

FIG. 1 is a diagram illustrating an outline of an operation of an information processing device according to an example embodiment 1.

FIG. 2 is a diagram exemplarily illustrating a configuration of the information processing device according to the example embodiment 1.

FIG. 3 is a diagram exemplarily illustrating a computer for achieving the information processing device.

FIG. 4 is a flowchart exemplarily illustrating a flow of processing executed by the example embodiment 1.

FIG. 5 is a diagram exemplarily illustrating a display screen including a total value of three sides of a circumscribed rectangular parallelepiped.

FIG. 6 is a diagram exemplarily illustrating price information in a table format.

FIG. 7 is a diagram exemplarily illustrating a usage environment of the information processing device in a usage example.

FIG. 8 is a diagram exemplarily illustrating a functional configuration of an information processing device according to an example embodiment 2.

FIG. 9 is a flowchart exemplarily illustrating a flow of processing executed by the information processing device according to the example embodiment 2.

FIG. 10 is a diagram exemplarily illustrating a suggestion notification that prompts deformation of a delivery object.

FIG. 11 is a diagram exemplarily illustrating a scene in which a rectangular parallelepiped is superimposed on an image of a delivery object and is output.

### EXAMPLE EMBODIMENT

Hereinafter, example embodiments of the present invention will be described with reference to the drawings. Note that the same components have the same reference numerals, and description thereof will not be repeated, as appropriate. Further, in each block diagram, each block represents a configuration of a functional unit instead of a configuration of a hardware unit unless otherwise described.

### Example Embodiment 1

### <Outline>

As a premise, when a shape of a delivery object is a rectangular parallelepiped, it is assumed that a total value (hereinafter, a total value of three sides) of lengths of a length, a width, and a height is used for determining a price of the delivery object. More specifically, a classification is provided in a numerical range which a total value of three sides may take, and a delivery price is previously associated with each classification. A delivery price of a delivery object is a delivery price associated with a classification including a total value of three sides of the delivery object. Further, for a delivery object having a shape other than a rectangular parallelepiped, a rectangular parallelepiped that can contain the delivery object therein is considered, and a delivery price associated with a classification in which a total value of three sides of the rectangular parallelepiped is included is adopted. Hereinafter, a classification in a numerical range which the total value of the three sides described above may take is referred to as a size classification.

However, an indicator that determines a delivery price may include not only a total value of three sides of a delivery object, but also another indicator such as a weight of a delivery object. For example, a classification (hereinafter, a weight classification) is provided in a numerical range which a weight of a delivery object may take, and a delivery price is associated with each weight classification. A delivery price of a delivery object is a higher delivery price of either a delivery price determined based on a total value of three sides thereof or a delivery price determined based on a weight thereof.

Hereinafter, a case where a delivery price is determined by a total value of three sides of a delivery object will be described for making description simple unless otherwise specified. When a delivery price is determined by also using another indicator, a delivery price of a delivery object is determined by using a delivery price based on a total value of three sides and a delivery price determined based on the another indicator, for example.

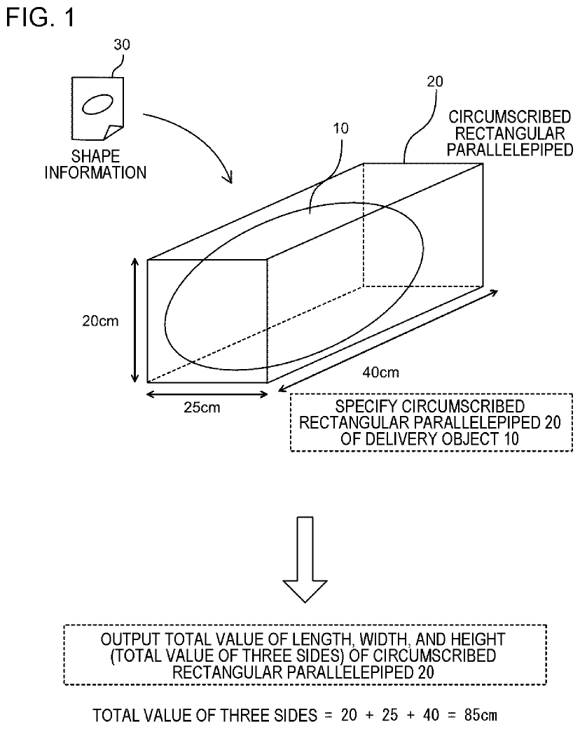

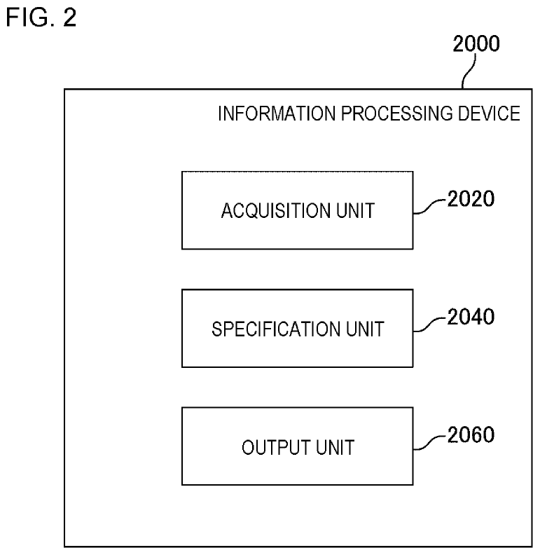

FIG. 1 is a diagram illustrating an outline of an operation of an information processing device (information processing device 2000 illustrated in FIG. 2) according to an example embodiment 1. FIG. 1 is a schematic diagram for facilitating understanding of the operation of the information processing device 2000, and does not specifically limit the operation of the information processing device 2000.

The information processing device 2000 acquires shape information 30 indicating a three-dimensional shape of a delivery object 10. For example, a circumscribed rectangular parallelepiped 20 is point group data representing a position of each of a plurality of points on an outer surface of the delivery object 10. The information processing device 2000 specifies a rectangular parallelepiped (hereinafter, the circumscribed rectangular parallelepiped 20) circumscribed on the delivery object 10, based on the shape information 30. Then, the information processing device 2000 computes a total value of three sides of the specified circumscribed rectangular parallelepiped 20, and outputs information representing the total value of the three sides.

In FIG. 1, lengths of a length, a width, and a height of the circumscribed rectangular parallelepiped 20 are 20 cm, 25 cm, and 40 cm, respectively. Thus, a total value of the three sides of the circumscribed rectangular parallelepiped 20 is 85 cm. Then, the information processing device 2000 outputs the information representing the total value of the three sides of “85 cm”.

In this example, it is assumed that there is a size classification that “greater than 80 cm and less than or equal to 100 cm”. In this case, a delivery price of the delivery object 10 is a delivery price associated with the size classification.

### Advantageous Effect

When the delivery object 10 having a shape other than a rectangular parallelepiped is handled, a person regards the delivery object 10 as a rectangular parallelepiped, measures lengths of a length, a width, and a height, and determines a delivery price according to the total value of the three sides. In this case, there are conceivably many cases where the delivery object 10 cannot be accurately regarded as a rectangular parallelepiped, and thus there is a risk that a delivery price cannot be accurately determined.

In this point, the information processing device 2000 according to the present example embodiment specifies the circumscribed rectangular parallelepiped 20 of the delivery object 10 by using the shape information 30 representing a three-dimensional shape of the delivery object 10, and outputs a total value of three sides, based on the specification. In this way, the total value of the three sides when the delivery object 10 is regarded as a rectangular parallelepiped can be computed with high accuracy, and thus a delivery price of the delivery object 10 can be accurately determined.

Further, in a method of regarding the delivery object 10 as a rectangular parallelepiped by a person and determining a delivery price, it is difficult to objectively judge whether the delivery object 10 can be accurately regarded as the rectangular parallelepiped. Thus, when an operator (hereinafter, a reception operator) who receives a delivery request measures a total value of three sides of the delivery object 10 and determines a delivery price, a client who requests the delivery may feel dissatisfied about the determination of the delivery price. On the other hand, when the client measures the total value of the three sides of the delivery object 10 and declares a result of the measurement to the reception operator, it is difficult for the reception operator to judge whether to trust the declaration by the client.

In this point, when the information processing device 2000 according to the present example embodiment is used, a delivery price is determined based on a total value of three sides output from a computer, and thus it can be said that a degree of reliability is increased from an objective viewpoint as compared to a case where a delivery price is determined based on a total value of three sides computed by regarding the delivery object 10 as a rectangular parallelepiped by a person. Thus, for example, even when the reception operator specifies a total value of three sides of the delivery object 10 by using the information processing device 2000 and determines a delivery price, it is conceivable that the client does not feel dissatisfied about the determination. Similarly, even when the client specifies a total value of three sides of the delivery object 10 by using the information processing device 2000, determines a delivery price, and declares the delivery price to the reception operator, it can be said that the reception operator can trust the declaration by the client. In this way, the information processing device 2000 can smoothly perform a request and a reception of a delivery of the delivery object 10 having a shape other than a rectangular parallelepiped.

Hereinafter, the information processing device 2000 according to the present example embodiment will be described in more detail.

### <Example of Functional Configuration of Information Processing Device 2000>

FIG. 2 is a diagram exemplarily illustrating a configuration of the information processing device 2000 according to the example embodiment 1. The information processing device 2000 includes an acquisition unit 2020, a specification unit 2040, and an output unit 2060. The acquisition unit 2020 acquires the shape information 30 indicating a three-dimensional shape of the delivery object 10. The specification unit 2040 specifies the circumscribed rectangular parallelepiped 20 circumscribed on the delivery object 10 by using the shape information 30. Furthermore, the specification unit 2040 computes and outputs a total value of three sides (total value of lengths of a length, a width, and a height) of the circumscribed rectangular parallelepiped 20.

### <Hardware Configuration of Information Processing Device 2000>

Each functional component unit of the information processing device 2000 may be achieved by hardware (for example, a hard-wired electronic circuit, or the like) that achieves each functional component unit, and may be achieved by a combination of hardware and software (for example, a combination of an electronic circuit and a program that controls the electronic circuit, or the like). Hereinafter, a case where each functional component unit of the information processing device 2000 is achieved by the combination of hardware and software will be further described.

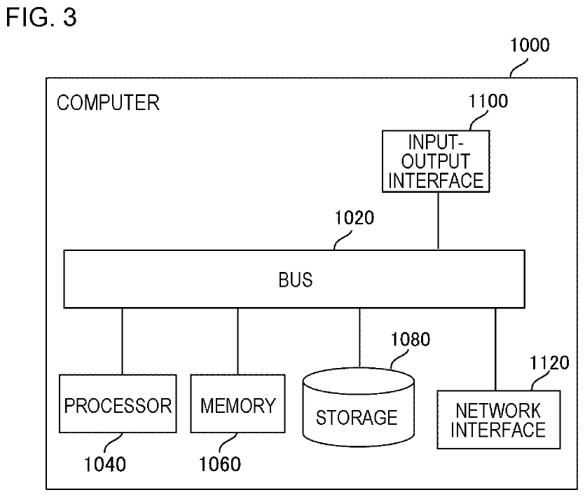

FIG. 3 is a diagram exemplarily illustrating a computer 1000 for achieving the information processing device 2000. The computer 1000 is any computer. For example, the computer 1000 is a portable terminal such as a smartphone and a tablet terminal. In addition, for example, the computer 1000 may be a personal computer (PC) and a server machine. The computer 1000 may be a dedicated computer designed for achieving the information processing device 2000, and may be a general-purpose computer.

The computer 1000 includes a bus 1020, a processor 1040, a memory 1060, a storage device 1080, an input-output interface 1100, and a network interface 1120. The bus 1020 is a data transmission path for allowing the processor 1040, the memory 1060, the storage device 1080, the input-output interface 1100, and the network interface 1120 to transmit and receive data with one another. However, a method of connecting the processor 1040 and the like to each other is not limited to a bus connection. The processor 1040 is a processor such as a central processing unit (CPU), a graphics processing unit (GPU), or a field-programmable gate array (FPGA). The memory 1060 is a main storage device achieved by using a random access memory (RAM) and the like. The storage device 1080 is an auxiliary storage device achieved by using a hard disk drive, a solid state drive (SSD), a memory card, a read only memory (ROM), or the like. However, the storage device 1080 may be constituted by hardware similar to hardware constituting the main storage device, such as the RAM.

The input-output interface 1100 is an interface for connecting the computer 1000 and an input-output device. The network interface 1120 is an interface for connecting the computer 1000 to a communication network. The communication network is, for example, a local area network (LAN) and a wide area network (WAN). A method of connection to the communication network by the network interface 1120 may be a wireless connection or a wired connection.

The storage device 1080 stores a program module that achieves the functional component unit of the information processing device 2000. The processor 1040 achieves a function associated with each program module by reading each of the program modules to the memory 1060 and executing the read program module.

### <Flow of Processing>

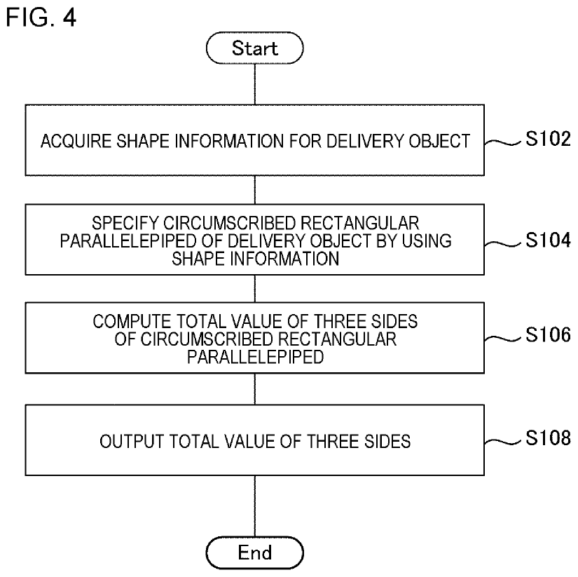

FIG. 4 is a flowchart exemplarily illustrating a flow of processing executed by the example embodiment 1. The acquisition unit 2020 acquires the shape information 30 for the delivery object 10 (S102). The specification unit 2040 specifies the circumscribed rectangular parallelepiped 20 of the delivery object 10 by using the shape information 30 (S104). The specification unit 2040 computes a total value of three sides of the circumscribed rectangular parallelepiped 20 (S106). The output unit 2060 outputs the computed total value of the three sides (S108).

### <With Regard to Delivery Object 10>

The delivery object 10 is an object to be delivered, and can have any shape. Herein, a shape of the delivery object 10 may be a rectangular parallelepiped. When the shape of the delivery object 10 is the rectangular parallelepiped, a shape of the circumscribed rectangular parallelepiped 20 specified by the specification unit 2040 substantially coincides with the shape of the delivery object 10.

### <Acquisition of Shape Information 30: S102>

The acquisition unit 2020 acquires the shape information 30 for the delivery object 10 (S102). As mentioned above, the shape information 30 is a piece of data representing a three-dimensional shape of the delivery object 10. Herein, as a method of representing a three-dimensional shape of a three-dimensional object with data, various types of existing methods such as a method of representing a three-dimensional shape with point group data and a method of representing a three-dimensional shape with plane data can be used.

Various types of existing methods can be used as a method of generating the shape information 30, namely, a method of generating data representing a three-dimensional shape of the delivery object 10. For example, data representing a three-dimensional shape of the delivery object 10 can be generated by scanning the delivery object 10 by using a three-dimensional scanner. In addition, for example, data representing a three-dimensional shape of the delivery object 10 can be generated by image-analyzing a plurality of captured images generated by capturing an image of the delivery object 10 from a plurality of directions.

There are various types of methods of acquiring the shape information 30 by the acquisition unit 2020. For example, the acquisition unit 2020 acquires the shape information 30 from a storage device that stores the shape information 30. In addition, for example, the acquisition unit 2020 acquires the shape information 30 by receiving the shape information 30 transmitted by a device that generates the shape information 30.

### <Specification of Circumscribed Rectangular Parallelepiped 20: S104>

The specification unit 2040 specifies the circumscribed rectangular parallelepiped 20 by using the shape information 30. Herein, an existing technique can be used as a technique for specifying a rectangular parallelepiped circumscribed on a three-dimensional shape. For example, the specification unit 2040 specifies a rectangular parallelepiped with a longest portion of the delivery object 10 as a diagonal line, and sets the specified rectangular parallelepiped as the circumscribed rectangular parallelepiped 20. Note that the longest portion of the delivery object 10 can be acquired by computing a distance between vertexes for a plurality of vertexes of the delivery object 10 indicated by the shape information 30, and connecting two vertexes having the longest distance.

In addition, for example, the specification unit 2040 may specify a rectangular parallelepiped with a longest portion of the delivery object 10 as one side, and set the specified rectangular parallelepiped as the circumscribed rectangular parallelepiped 20.

### <<With Regard to Size of Circumscribed Rectangular Parallelepiped 20>>

In order to compute a total value of three sides of the circumscribed rectangular parallelepiped 20, not only a shape of the circumscribed rectangular parallelepiped 20 but also a size of the circumscribed rectangular parallelepiped 20 needs to be specified. To do so, the shape information 30 needs to include not only information related to a shape but also information related to a size in a real space.

In this point, information related to a size in a real space is also generally included in point group data acquired by using a three-dimensional scanner. For example, coordinates of each point are determined in such a way that a value of a distance between each of points of point group data is equal to a value of a distance between positions in a real space corresponding to the points.

When the shape information 30 is generated by using a captured image generated by a camera, an object having a known size is included in an imaging range of the camera, for example. For example, a delivery slip and the like having a known size thereof are provided to an outer surface of the delivery object 10. In this way, information related to a size in a real space of the delivery object 10, based on a shape and a size of the delivery slip in a captured image, can be included in a three-dimensional shape of the delivery object generated by using the captured image. Specifically, information similar to point group data acquired from the three-dimensional scanner described above can be generated as the shape information 30.

### <Output of Computed Total Value: S108>

The output unit 2060 outputs the total value of the three sides of the circumscribed rectangular parallelepiped 20 computed by the specification unit 2040 (S108). For example, the output unit 2060 outputs a display screen indicating the total value of the three sides. For example, the output unit 2060 controls a display device, and displays the display screen on the display device. In addition, for example, the output unit 2060 may transmit, to another device, information (for example, an HTML file and an image referred from the HTML file) representing a display screen. In this case, the device that receives the display screen from the output unit 2060 controls a display device, and displays the display screen on the display device.

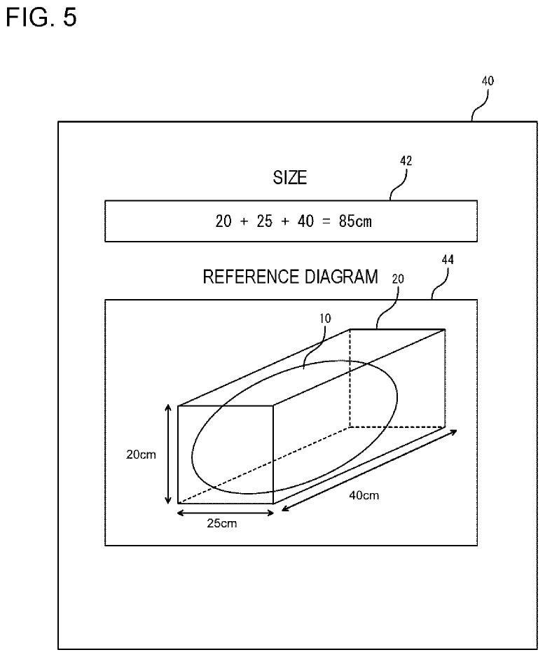

FIG. 5 is a diagram exemplarily illustrating a display screen including a total value of three sides of the circumscribed rectangular parallelepiped 20. A display screen 40 includes a display area 42 and a display area 44. The display area 42 is a screen area in which a total value of three sides is displayed. The display area 44 is a screen area in which the circumscribed rectangular parallelepiped 20 is displayed.

In the display area 44, the circumscribed rectangular parallelepiped 20 is superimposed on an image representing the delivery object 10 and is displayed. The image representing the delivery object 10 may be an image of the delivery object 10 acquired by capturing the delivery object 10 by a camera, and an image representing a shape of the delivery object 10 generated by using the shape information 30. Note that the image of the delivery object 10 may be usable to compare a shape and a size of the delivery object 10 with those of the circumscribed rectangular parallelepiped 20, and another element (for example, a pattern on a surface, or the like) of the delivery object 10 may be omitted.

By displaying a total value of three sides on the display device in this way, a user of the information processing device 2000 can easily recognize the total value of the three sides used for computing a delivery price of the delivery object 10. Furthermore, by superimposing the circumscribed rectangular parallelepiped 20 on the image of the delivery object 10 and displaying the circumscribed rectangular parallelepiped 20 on the display device, a user of the information processing device 2000 can visually recognize that the circumscribed rectangular parallelepiped 20 acquired by regarding the delivery object 10 as a rectangular parallelepiped is appropriate.

### <With Regard to Delivery Price>

The output unit 2060 may specify a delivery price of the delivery object 10, based on a total value of three sides of the circumscribed rectangular parallelepiped 20, and output the specified delivery price. For example, the delivery price is included in the display screen 40 described above. Further, the output unit 2060 may output information (name of a size classification and a range of a total value of three sides included in a size classification) representing a size classification including a total value of three sides of the circumscribed rectangular parallelepiped 20 in addition to or instead of the delivery price.

When a delivery price is determined based on a total value of three sides, the output unit 2060 needs to be able to recognize association between the size classification mentioned above and the delivery price. For example, the output unit 2060 acquires a delivery price associated with a size classification including a total value of three sides of the circumscribed rectangular parallelepiped 20 from a storage device that stores information (hereinafter, price information) in which the size classification and the delivery price are associated with each other.

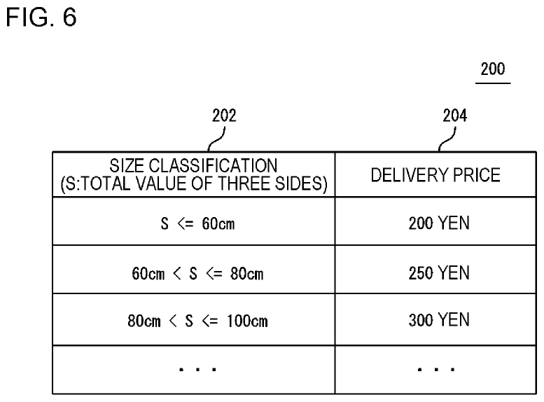

FIG. 6 is a diagram exemplarily illustrating price information in a table format. A table illustrated in FIG. 6 is referred to as a table 200. The table 200 illustrates a delivery price 204 in association with a size classification 202. For example, when a total value of three sides of the circumscribed rectangular parallelepiped 20 is “85 cm”, a delivery price is “300 yen”.

### <Usage Example>

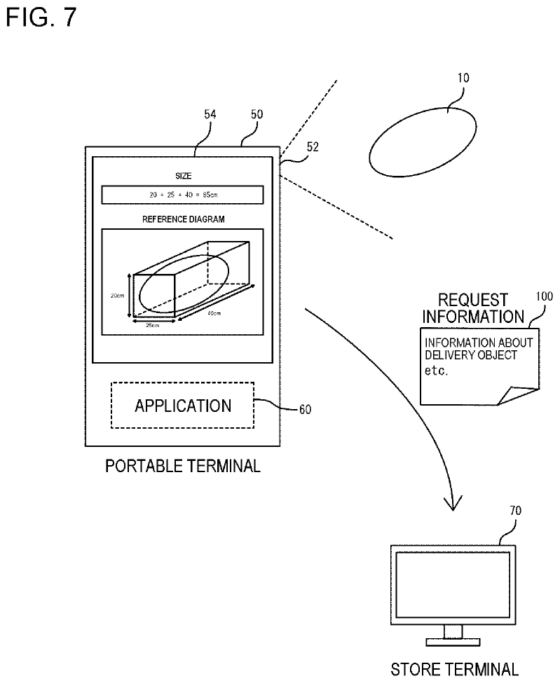

Hereinafter, a specific usage example of the information processing device 2000 will be described. FIG. 7 is a diagram exemplarily illustrating a usage environment of the information processing device 2000 in the usage example. In FIG. 7, the information processing device 2000 is achieved as a portable terminal 50. Specifically, an application 60 that achieves a function of the information processing device 2000 is installed in the portable terminal 50. The portable terminal 50 is, for example, a portable terminal possessed by a customer (hereinafter, a client) who requests delivery of the delivery object 10. However, the portable terminal 50 may be a portable terminal placed at a store where delivery request is received, and a portable terminal possessed by a person who collects the delivery object 10.

The client activates the application 60, and captures the delivery object 10 with a camera 52 provided in the portable terminal 50. As a result, the application 60 generates the shape information 30 by using a captured image generated by the camera 52.

The application 60 specifies the circumscribed rectangular parallelepiped 20 by using the shape information 30, and computes a total value of three sides for the specified circumscribed rectangular parallelepiped 20. Furthermore, the application 60 determines a delivery price of the delivery object 10, based on the total value of the three sides.

The application 60 displays the display screen 40 mentioned above on a display device 54 of the portable terminal 50. The client views the display screen 40, and checks appropriateness of the circumscribed rectangular parallelepiped 20 and the delivery price.

The application 60 generates request information 100 used for a delivery request of the delivery object 10 by using a result of the series of operations described above. The request information 100 includes at least information related to the delivery object 10 being generated by the application 60. For example, the information related to the delivery object 10 includes an image of the delivery object 10, three-dimensional data representing the circumscribed rectangular parallelepiped 20, a total value of three sides of the circumscribed rectangular parallelepiped 20, and a delivery price based on the total value of the three sides. Furthermore, the application 60 may receive an input of other information (a name of the delivery object 10, a type of the delivery object 10, whether the delivery object 10 is a fragile object, whether the delivery object 10 needs to be refrigerated, or the like) related to the delivery object 10, and include the received information in the request information 100.

The request information 100 may further include information related to a client and a delivery destination. The information related to a client includes, for example, a name, an address, a phone number, and the like of the client. Further, the information related to the client may indicate a user ID of a user account being previously generated in addition or instead of the information described above. The information related to a delivery destination includes, for example, an address of the delivery destination, a name and a phone number of a recipient, and the like.

A client can perform an operation for generating the request information 100 at any place. For example, after a client performs generation of the request information 100 at home, an office, or the like, the client goes to a store where the client requests delivery of the delivery object 10. Further, when a client requests collection of the delivery object 10, the client performs generation of the request information 100 before a person who collects the delivery object 10 comes to a collection place.

A reception operator who receives a request of delivery from a client receives the request of the delivery by operating a reception terminal 70 and acquiring the request information 100. The reception terminal 70 is, for example, a terminal prepared at a store where a request of delivery is received. In addition, for example, when a reception operator goes to a house or an office of a client and collects the delivery object 10, the reception terminal 70 may be a portable terminal carried by the reception operator.

Any method of acquiring the request information 100 by the reception terminal 70 is used. For example, the reception terminal 70 acquires the request information 100 from the application 60 by performing wireless communication with the application 60. In addition, for example, the application 60 may encode the request information 100 to a code such as a QR code (registered trademark), and display the encoded code on the display device 54. In this case, the reception terminal 70 acquires the request information 100 by reading the code displayed on the display device 54. Note that an existing technique can be used as a technique for acquiring information by reading a code displayed on a display device.

In addition, for example, the request information 100 may be able to be previously registered in a Web system and the like. In this case, a client accesses a Web page that provides the Web system described above, and performs registration of the request information 100. The request information 100 is registered in association with a user account of the client. The reception terminal 70 receives a delivery request by acquiring the request information 100 registered in association with a user ID of the client from the Web system described above. Note that it is suitable that a request for collection of the delivery object 10 can be performed together when the request information 100 is registered in the Web system.

### Example Embodiment 2

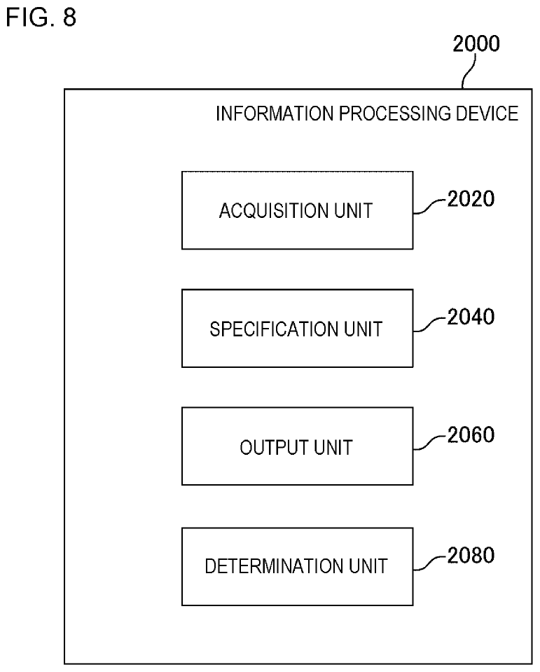

FIG. 8 is a diagram exemplarily illustrating a functional configuration of an information processing device 2000 according to an example embodiment 2. The information processing device 2000 according to the example embodiment 2 has a function similar to that of the information processing device 2000 according to the example embodiment 1 except for a point described below.

The delivery object 10 may be reduced in size by changing a shape of the delivery object 10. For example, when a material of a delivery object is a soft material to some extent such as paper, cloth, or leather, the delivery object 10 can be reduced in size by folding the material or squeezing the material.

When the delivery object 10 can be deformed in this way, a delivery price may be reduced by appropriately deforming the delivery object 10 and reducing the size of the delivery object 10. As mentioned above, a delivery price of the delivery object 10 is associated with a size classification associated with a total value of three sides of the circumscribed rectangular parallelepiped 20. Thus, a delivery price can be reduced when the delivery object 10 can be deformed in such a way that a total value of three sides of the circumscribed rectangular parallelepiped 20 becomes smaller until a size classification associated with the total value of the three sides of the circumscribed rectangular parallelepiped 20 changes.

Then, the information processing device 2000 according to the example embodiment 2 includes a determination unit 2080 that determines whether there is a high probability that a size classification associated with the delivery object 10 can be changed by reducing the size of the delivery object 10. When it is determined that there is a high probability that the size classification associated with the delivery object 10 can be changed by reducing the size of the delivery object 10, an output unit 2060 according to the example embodiment 2 outputs a notification (hereinafter, a suggestion notification) indicating a suggestion related to deformation of the delivery object 10. For example, the suggestion notification is included together with a total value of three sides of the circumscribed rectangular parallelepiped 20 in the display screen 40. On the other hand, when it is determined that there is no high probability that the size classification associated with the delivery object 10 can be changed by reducing the size of the delivery object 10, the output unit 2060 does not output the suggestion notification. Note that a situation where “there is a high probability that the size classification associated with the delivery object 10 can be changed by reducing the size of the delivery object 10” herein may not need to be in consideration of whether the delivery object 10 is a material that can be easily deformed, and may be on the assumption that the delivery object 10 is a material that can be easily deformed.

### Advantageous Effect

The information processing device 2000 according to the present example embodiment outputs a notification that suggests deformation of the delivery object 10 when there is a high probability that a size classification associated with the delivery object 10 can be changed by deforming the delivery object 10 to be smaller, that is, when there is a high probability that a delivery price of the delivery object 10 can be reduced by deforming the delivery object 10 to be smaller. Thus, a client can recognize that there is a high probability that the delivery price of the delivery object 10 can be reduced.

### <Example of Hardware Configuration>

A hardware configuration of a computer that achieves the information processing device 2000 according to the example embodiment 2 is represented in FIG. 3, for example, similarly to the example embodiment 1. However, a program module that achieves a function of the information processing device 2000 according to the present example embodiment is further stored in a storage device 1080 of a computer 1000 that achieves the information processing device 2000 according to the present example embodiment.

### <Flow of Processing>

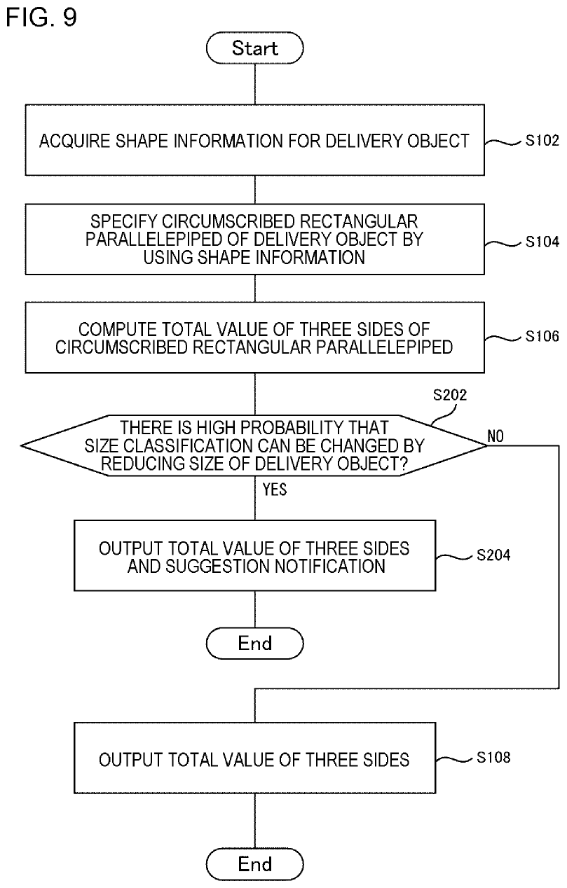

FIG. 9 is a flowchart exemplarily illustrating a flow of processing executed by the information processing device 2000 according to the example embodiment 2. Herein, the processing common to the flowcharts in FIGS. 9 and 4 is denoted by the same reference sign. After S106, the determination unit 2080 determines whether there is a high probability that a size classification associated with the delivery object 10 can be changed by reducing the size of the delivery object 10 (S202). When it is determined that there is a high probability that the size classification associated with the delivery object 10 can be changed by reducing the size of the delivery object 10 (S202: YES), the output unit 2060 outputs the suggestion notification together with the total value of the three sides of the circumscribed rectangular parallelepiped 20 (S204). On the other hand, when it is determined that there is no high probability that the size classification associated with the delivery object 10 can be changed by reducing the size of the delivery object 10 (S202: NO), the output unit 2060 outputs the total value of the three sides of the circumscribed rectangular parallelepiped 20 (S108).

### <Determination by Determination Unit 2080: S202>

The determination unit 2080 determines whether there is a high probability that the size classification associated with the delivery object 10 can be changed by reducing the size of the delivery object 10 (S202). For example, the determination unit 2080 determines whether a total value of three sides of the circumscribed rectangular parallelepiped 20 and a lower limit value of a size classification associated with the total value of the three sides satisfy a predetermined relationship.

The predetermined relationship being satisfied represents that there is a high probability that the size classification associated with the delivery object 10 can be changed by reducing the size of the delivery object 10. More specifically, the predetermined relationship described above represents that there is a high probability that the total value of the three sides of the circumscribed rectangular parallelepiped 20 is not included in a current size classification (included in one lower size classification) by reducing the size of the delivery object 10. For example, when a difference between a total value of three sides of the circumscribed rectangular parallelepiped 20 and a lower limit value of a size classification associated with the total value of the three sides is small enough, it can be said that there is a high probability that a delivery price of the delivery object 10 can be reduced by reducing the size of the delivery object 10. On the other hand, when a difference between a total value of three sides of the circumscribed rectangular parallelepiped 20 and a lower limit value of a size classification associated with the total value of the three sides is great, it can be said that it is difficult to reduce the size of the delivery object 10 to the extent that the size classification can be changed.

Then, for example, as the predetermined relationship described above, a relationship that “a difference between a total value of three sides of the circumscribed rectangular parallelepiped 20 and a lower limit value of a size classification associated with the total value of the three sides is less than or equal to a predetermined value” or a relationship that “a ratio of a size lower limit value associated with a total value of three sides of the circumscribed rectangular parallelepiped 20 to the total value of the three sides is less than or equal to a predetermined value” can be adopted.

### <With Regard to Notification by Output Unit 2060>

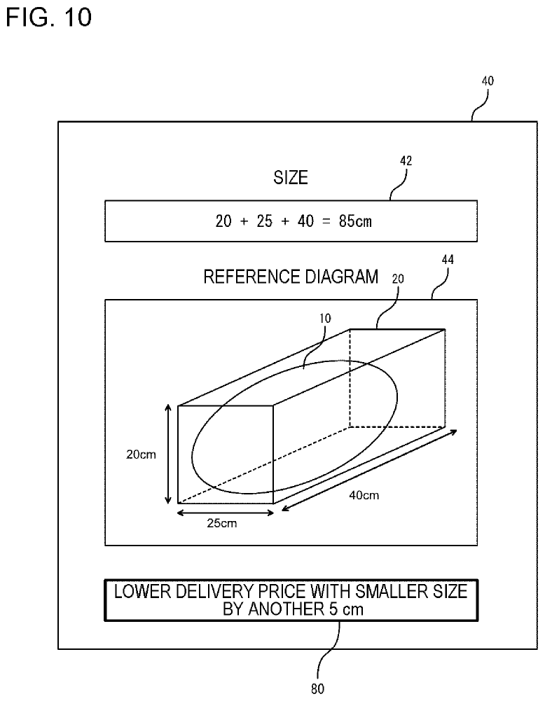

When it is determined that there is a high probability that the size classification associated with the delivery object 10 can be changed by reducing the size of the delivery object 10 (S202: YES), the output unit 2060 outputs the suggestion notification (S204). The suggestion notification is, for example, a message that prompts deformation of the delivery object 10. FIG. 10 is a diagram exemplarily illustrating a suggestion notification that prompts deformation of the delivery object 10. In FIG. 10, the suggestion notification is a message 80 and is included in a display screen 40. Note that it is assumed that a delivery price is determined based on the table 200 in FIG. 6.

Information representing a candidate for deformation performed on the delivery object 10 may be included in the suggestion notification. Herein, in order to reduce the delivery price of the delivery object 10, the delivery object 10 may be deformed in such a way that a size classification associated with a total value of three sides of the circumscribed rectangular parallelepiped 20 becomes one lower size classification. Then, the output unit 2060 generates an image of a rectangular parallelepiped associated with one lower size classification than the size classification associated with the total value of the three sides of the circumscribed rectangular parallelepiped 20, superimposes the generated image of the rectangular parallelepiped on an image of the delivery object 10, and outputs the image. A client can easily recognize how the delivery object 10 is preferably deformed by viewing the image of the rectangular parallelepiped.

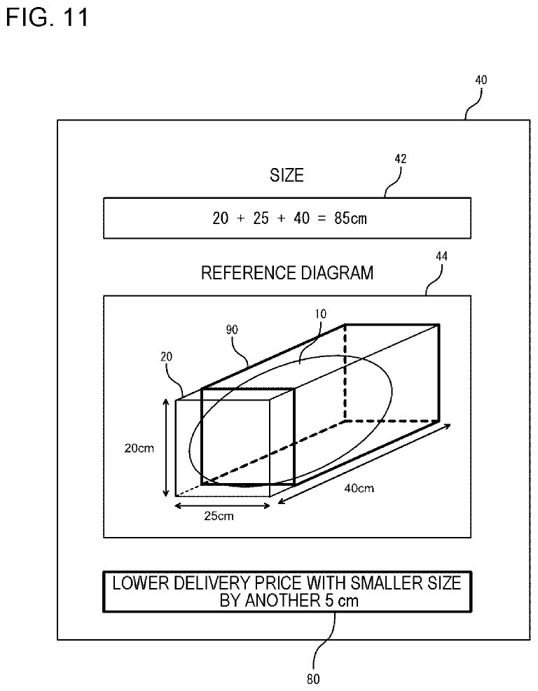

FIG. 11 is a diagram exemplarily illustrating a scene in which a rectangular parallelepiped 90 is superimposed on an image of the delivery object 10 and is output. It is assumed that a delivery price is determined based on the table 200 in FIG. 6. The circumscribed rectangular parallelepiped 20 is included in a size classification that “greater than 80 cm and less than or equal to 100 cm” in a current situation. Thus, when the delivery object 10 is deformed and the circumscribed rectangular parallelepiped 20 is included in a size classification that “greater than 60 cm and less than or equal to 80 cm”, the delivery price of the delivery object 10 is reduced. Thus, in the display screen 40 in FIG. 11, the rectangular parallelepiped 90 having a total value of three sides of 80 cm is superimposed on the image of the delivery object 10.

The rectangular parallelepiped 90 is generated based on the circumscribed rectangular parallelepiped 20. For example, the information processing device 2000 generates the rectangular parallelepiped 90 by shortening the longest side among a length, a width, and a height of the circumscribed rectangular parallelepiped 20. Specifically, the information processing device 2000 computes a difference between a total value of three sides of the circumscribed rectangular parallelepiped 20 and an upper limit value of one lower size classification than a size classification associated with the total value of the three sides. Then, the information processing device 2000 generates the rectangular parallelepiped 90 by shortening the longest side among the length, the width, and the height of the circumscribed rectangular parallelepiped 20 to more than the above difference.

In addition, for example, the information processing device 2000 may generate the rectangular parallelepiped 90 by reducing each side of the circumscribed rectangular parallelepiped 20 with the same magnification. Specifically, the information processing device 2000 computes, as a reduction ratio, a value acquired by dividing an upper limit value of one lower size classification than a size classification associated with a total value of three sides of the circumscribed rectangular parallelepiped 20 by the total value of the three sides of the circumscribed rectangular parallelepiped 20. Then, the information processing device 2000 sets a rectangular parallelepiped acquired by multiplying each side of the circumscribed rectangular parallelepiped 20 by the reduction ratio as the rectangular parallelepiped 90.

While the example embodiments of the present invention have been described with reference to the drawings, the example embodiments are only exemplification of the present invention, and combination of each of the above-described example embodiments or various configurations other than the above-described example embodiments can also be employed.

A part or the whole of the above-described example embodiments may also be described as in supplementary notes below, which is not limited thereto.
1. An information processing device, including:

an acquisition unit that acquires shape information indicating a three-dimensional shape of a delivery object;

a specification unit that specifies a first rectangular parallelepiped circumscribed on the delivery object by using the shape information, and computes a total value of lengths of a length, a width, and a height of the first rectangular parallelepiped; and

an output unit that outputs the computed total value.
2. The information processing device according to supplementary note 1,

in which the output unit superimposes an image of the first rectangular parallelepiped on an image of the delivery object and outputs the superimposed image.
3. The information processing device according to supplementary note 1 or 2,

in which a delivery price of a delivery object is determined in association with each classification acquired by dividing a numerical range of a total value of a length, a width, and a height of a rectangular parallelepiped including a delivery object into a plurality of numerical ranges, and

in which the output unit outputs the classification including the computed total value or information representing the delivery price associated with the classification.
4. The information processing device according to any one of supplementary notes 1 to 3, further including a determination unit,

in which a delivery price of a delivery object is determined in association with each classification acquired by dividing a numerical range of a total value of a length, a width, and a height of a rectangular parallelepiped including a delivery object into a plurality of numerical ranges,

in which the determination unit determines whether there is a high probability that a delivery price of the delivery object can be reduced by deforming the delivery object and reducing a size of the delivery object,

in which the output unit further outputs a notification that prompts deformation of the delivery object when it is determined that there is a high probability that the delivery price of the delivery object can be reduced by deforming the delivery object and reducing a size of the delivery object.
5. The information processing device according to supplementary note 4,

in which the output unit includes, in the notification, information representing a candidate for deformation of the delivery object.
6. The information processing device according to supplementary note 5,

in which the information representing a candidate for deformation of the delivery object is an image acquired by superimposing, on an image of the delivery object, an image of a rectangular parallelepiped included in one-step lower classification than a classification associated with the computed total value.
7. A control method, including:

an acquisition step of acquiring shape information indicating a three-dimensional shape of a delivery object;

a specification step of specifying a first rectangular parallelepiped circumscribed on the delivery object by using the shape information, and computing a total value of lengths of a length, a width, and a height of the first rectangular parallelepiped; and

an output step of outputting the computed total value.
8. The control method according to supplementary note 7,

in which in the output step, an image of the first rectangular parallelepiped is superimposed on an image of the delivery object and the superimposed image is output.
9. The control method according to supplementary note 7 or 8,

in which a delivery price of a delivery object is determined in association with each classification acquired by dividing a numerical range of a total value of a length, a width, and a height of a rectangular parallelepiped including a delivery object into a plurality of numerical ranges, and

in which in the output step, the classification including the computed total value or information representing the delivery price associated with the classification is output.
10. The control method according to any one of supplementary notes 7 to 9, further including a determination step,

in which a delivery price of a delivery object is determined in association with each classification acquired by dividing a numerical range of a total value of a length, a width, and a height of a rectangular parallelepiped including a delivery object into a plurality of numerical ranges,

in which the determination step includes determining whether there is a high probability that a delivery price of the delivery object can be reduced by deforming the delivery object and reducing a size of the delivery object,

in which in the output step, a notification that prompts deformation of the delivery object is further output when it is determined that there is a high probability that the delivery price of the delivery object can be reduced by deforming the delivery object and reducing a size of the delivery object.
11. The control method according to supplementary note 10,

in which in the output step, information representing a candidate for deformation of the delivery object is includes in the notification.
12. The control method according to supplementary note 11,

in which the information representing a candidate for deformation of the delivery object is an image acquired by superimposing, on an image of the delivery object, an image of a rectangular parallelepiped included in one-step lower classification than a classification associated with the computed total value.
13. A program causing a computer to execute each step of the control method according to any one of supplementary notes 7 to 12.

This application is based upon and claims the benefit of priority from Japanese patent application No. 2018-052732, filed on Mar. 20, 2018, the disclosure of which is incorporated herein in its entirety by reference.

What is claimed is:

1. An information processing device, comprising:
an acquisition unit that acquires shape information indicating a three-dimensional shape of a delivery object;
a specification unit that specifies a first rectangular parallelepiped circumscribed on the delivery object by using the shape information, and computes a total value of lengths of a length, a width, and a height of the first rectangular parallelepiped; and
an output unit that outputs the computed total value.

2. The information processing device according to claim 1,
wherein the output unit superimposes an image of the first rectangular parallelepiped on an image of the delivery object and outputs the superimposed image.

3. The information processing device according to claim 1,
wherein a delivery price of a delivery object is determined in association with each classification acquired by dividing a numerical range of a total value of a length, a width, and a height of a rectangular parallelepiped including a delivery object into a plurality of numerical ranges, and
wherein the output unit outputs the classification including the computed total value or information representing the delivery price associated with the classification.

4. The information processing device according to claim 1, further comprising a determination unit,
wherein a delivery price of a delivery object is determined in association with each classification acquired by dividing a numerical range of a total value of a length, a width, and a height of a rectangular parallelepiped including a delivery object into a plurality of numerical ranges,
wherein the determination unit determines whether there is a high probability that a delivery price of the delivery object can be reduced by deforming the delivery object and reducing a size of the delivery object, and
wherein the output unit further outputs a notification that prompts deformation of the delivery object when it is determined that there is a high probability that a delivery price of the delivery object can be reduced by deforming the delivery object and reducing a size of the delivery object.

5. The information processing device according to claim 4,
wherein the output unit includes, in the notification, information representing a candidate for deformation of the delivery object.

6. The information processing device according to claim 5,
wherein the information representing a candidate for deformation of the delivery object is an image acquired by superimposing, on an image of the delivery object, an image of a rectangular parallelepiped included in one-step lower classification than a classification associated with the computed total value.

7. A control method, comprising:
an acquisition step of acquiring shape information indicating a three-dimensional shape of a delivery object;
a specification step of specifying a first rectangular parallelepiped circumscribed on the delivery object by using the shape information, and computing a total value of lengths of a length, a width, and a height of the first rectangular parallelepiped; and
an output step of outputting the computed total value.

8. The control method according to claim 7,
wherein in the output step, an image of the first rectangular parallelepiped is superimposed on an image of the delivery object and the superimposed image is output.

9. The control method according to claim 7,
wherein a delivery price of a delivery object is determined in association with each classification acquired by dividing a numerical range of a total value of a length, a width, and a height of a rectangular parallelepiped including a delivery object into a plurality of numerical ranges, and
wherein in the output step, the classification including the computed total value or information representing the delivery price associated with the classification is output.

10. The control method according to claim 1, further comprising a determination step,
wherein a delivery price of a delivery object is determined in association with each classification acquired by dividing a numerical range of a total value of a length, a width, and a height of a rectangular parallelepiped including a delivery object into a plurality of numerical ranges,
wherein the determination step includes determining whether there is a high probability that a delivery price of the delivery object can be reduced by deforming the delivery object and reducing a size of the delivery object, and
wherein in the output step, a notification that prompts deformation of the delivery object is further output when it is determined that there is a high probability that a delivery price of the delivery object can be reduced by deforming the delivery object and reducing a size of the delivery object.

11. The control method according to claim 10,
wherein in the output step, information representing a candidate for deformation of the delivery object is included in the notification.

12. The control method according to claim 11,
wherein the information representing a candidate for deformation of the delivery object is an image acquired by superimposing, on an image of the delivery object, an image of a rectangular parallelepiped included in one-step lower classification than a classification associated with the computed total value.

13. A non-transitory computer readable medium storing a program causing a computer to execute each step of a control method, the method comprising:
an acquisition step of acquiring shape information indicating a three-dimensional shape of a delivery object;
a specification step of specifying a first rectangular parallelepiped circumscribed on the delivery object by using the shape information, and computing a total value of lengths of a length, a width, and a height of the first rectangular parallelepiped; and
an output step of outputting the computed total value.
